(19) United States
(12) Patent Application Publication
(10) Pub. No.: US 2006/0233582 A1
(43) Pub. Date: Oct. 19, 2006

(54) Tape cassette

(75) Inventor: Takashi Horiuchi, Kariya-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 11/389,140

(22) Filed: Mar. 27, 2006

(30) Foreign Application Priority Data
Mar. 30, 2005 (JP) 2005-099313

(51) Int. Cl. B41J 35/28

(52) U.S. Cl. 400/208

(57) ABSTRACT

It is intended to provide a tape cassette which has logos including characters and symbols, formed in a position facing to feed paths of tapes an ink ribbon in an outer wall face of the cassette case. The tape cassette, in which the tapes and the ink ribbon are appropriately fed with a logo part, provides a reinforcement and a feeding restricting part for restricting the tapes and the ink ribbon in width direction, or a reference face. The tape cassette is provided with the logos formed in the recessed shape in the position facing to the feed guidance in a logo formed part the outer wall face of the lower case, and the protrusive part formed in the inner wall face of the lower case as the logos are formed and providing a feeding restricting part for restricting movement of the printing tape and the ink ribbon in the respective width.

### TECHNICAL FIELD

The disclosure relates to a tape cassette in which a cassette case has at least a tape spool on which a printing tape is wound, and the printing tape is unwound from the tape spool along a predetermined feed path, and then discharged out of the cassette case.

### BACKGROUND

Conventionally, various types of tape cassettes to be used in a tape printer to produce a characters-printed tape have been proposed. The tape cassette generally includes a ribbon spool on which an ink ribbon is wound and tape spools on which a printing tape and a double-sided adhesive tape are wound in a cassette case. In making the characters-printed tape, the printing tape is printed characters by a thermal head provided in the tape printer with the ink ribbon, while the printing tape is fed with the ink ribbon together. The double-sided adhesive tape is adhered to a printed face of the printing tape. Finally, the characters-printed tape is produced.

In another case, the cassette case has a heat-sensitive printing tape which is previously applied an adhesive on its back face is wound on the tape spool. In making the characters-printed tape, the heat-sensitive printing tape is fed and printed characters with the thermal head provided in the tape printer.

To perform a high-quality printing on the printing tape and the heat-sensitive printing tape which are housed in the tape cassette, and to feed the tapes and the ink ribbon properly, the tapes and the ink ribbon need to be fed along an appropriate feed path.

Japanese patent publication laid-open No. H7(1995)-314869 discloses a tape cassette which has a structure comprising a pair of restricting members formed in a side wall of the cassette case in a downstream side of a position where a tape is printed along a predetermined feed path. The '869 application also discloses an arm portion which guides the tapes unwound from the tape spools and the ink ribbon from the ink ribbon spool, and discharges them through an opening. The arm portion has a structure in which a partition wall to separate the tapes and the ink ribbon inside the arm portion is provided upright, and a pair of the restricting members like ribs to control the tapes are placed in both lower end of the partition wall. Further, a structure for positioning the tape cassette with two pin holes therein is also disclosed. These structures are intended to keep appropriate feeding of the tapes and the ink ribbon.

However, the arm portion disclosed in the '869 application is formed in a slender shape like a peninsula, and an end of the arm portion is not connected with any other parts. Therefore, if the rib is provided inside the arm portion for reinforcement, a problem may occur in the arm portion, which is deformed in injection molding of the cassette case because molding distortion included within the cassette case appears with time. As a result of the problem, the tapes and the ink ribbon cannot be fed properly.

Furthermore, to meet the demand for a thinner and lighter tape cassette, a cassette case thereof has been designed to have a minimum thickness. Therefore, when the cassette case is molded by injection with the rib which is provided in the partition wall of the arm portion, a shrinkage has stemmed from unevenness of resin shrinkage rate in the injection molding, and the required accuracy of dimension cannot be obtained. Further using the tape cassette under these conditions may prevent the tapes and the ink ribbon from running properly.

In addition, because of the deformation of the arm portion, the end of the arm portion can be hardly positioned with high precision only with two pin holes provided in the tape cassette.

### SUMMARY

The disclosure has been made in view of the above circumstances and has an object to overcome the above problems and to provide a tape cassette which has logos including the characters and the symbols, formed in a position facing to feed paths of tapes and ink ribbon in an outer wall face of the cassette case. The tape cassette in which the tapes and the ink ribbon are appropriately fed with a logo part, is formed with the logos and provides a reinforcement and a feeding restricting part for restricting movement of the tapes and the ink ribbon in respective width direction, or a reference face.

To achieve the purpose of the disclosure, there is provided a tape cassette including a cassette case housing a tape spool on which a printing tape is wound and an ink ribbon spool on which an ink ribbon is wound, in which the printing tape on which a character has been printed with the ink ribbon is discharged from the cassette case while the printing tape and the ink ribbon are unwound from the tape spool and the ink ribbon spool respectively along a predetermined feed guidance, the tape cassette comprising: a logo including a character and a symbol, formed in a recessed shape in a position facing to the feed guidance in an outer wall face of the cassette case; and a protrusive part formed in an inner wall face of the cassette case as the logo is formed, and providing a feeding restricting part for restricting movement of the printing tape and the ink ribbon in respective width direction.

The tape cassette according to the first aspect is provided with the logos including the characters and the symbols, formed in the recessed shape in the position facing to the feed guidance in the outer wall face of the cassette case, and the protrusive part formed in the inner wall face of the cassette case as the logos are formed and providing a feeding restricting part for restricting the movement of the printing tape and the ink ribbon in the respective width direction. Accordingly, the protrusive part is formed like the contiguous recessions and projections in the inner wall face of the cassette case, so that the strength of the parts can be enhanced rather than being a rib of a single plate, and molding distortion in injection molding can be saved. It becomes also possible to prevent a shrinkage which is caused by unevenness of resin shrinkage in the injection molding in the feeding restricting part like the rib of the single plate. As a result, a dimension of the feeding restricting part can be fixed, and then the printing tape and the ink ribbon can be fed properly.

According to another aspect of the disclosure, there is provided a tape cassette including a cassette case housing a tape spool on which a heat-sensitive printing tape is wound, in which the printing tape on which a character has been printed with the ink ribbon is discharged from the cassette case while the heat-sensitive printing tape is unwound from the tape spool along a predetermined feed guidance, the tape cassette comprising: a logo including a character and a symbol, formed in a recessed shape in a position facing to the feed guidance in an outer wall face of the cassette case; and a protrusive part formed in an inner wall face of the cassette case as the logo is formed, and providing a feeding restricting part for restricting movement of the heat-sensitive printing tape in width direction.

The tape cassette according to the second aspect is provided with the logos including the characters and the symbols, formed in the recessed shape in the position facing to the feed guidance, and the protrusive part formed in the inner wall face of the cassette case as the logos are formed and providing a feeding restricting part for restricting the movement of the heat-sensitive printing tape in the tape width direction. Accordingly, the protrusive part is formed like the contiguous recessions and projections in the inner wall face of the cassette case, so that the strength of the parts can be enhanced rather than being a rib of a single plate, and molding distortion in injection molding can be saved. It becomes also possible to prevent a shrinkage which is caused by unevenness of resin shrinkage in the injection molding in the feeding restricting part like the rib of the single plate. As a result, a dimension of the feeding restricting part can be fixed, and then the printing tape and the ink ribbon can be fed properly.

According to another aspect of the disclosure, there is provided a tape cassette including a cassette case housing a tape spool on which one of a printing tape and a heat-sensitive printing tape is wound, in which one of the printing tape and the heat-sensitive printing tape on which a character has been printed with the ink ribbon is discharged from the cassette case while one of the printing tape and the heat-sensitive printing tape is unwound from the tape spool and the ink ribbon spool respectively along a predetermined feed guidance, the tape cassette comprising: a protrusive logo including a character and a symbol, formed in a protruding shape in a position facing to the feed guidance in an outer wall face of the cassette case; and a top face of the protrusive logo is used as a reference face in a height direction of the tape cassette.

The tape cassette according to the third aspect is provided with the logos including the characters and the symbols, formed in the protruding shape in the position facing to the feed guidance in the outer wall face of the cassette case, and the top face of the protrusive logo is used as the reference face in the height direction of the tape cassette. Accordingly, it becomes possible to position the tape cassette in the height direction with the top face of the protrusive logos which feeds the printing tape and the ink ribbon for printing of the characters. The tape cassette can be also positioned by the three points including the top face of the protrusive logos and two pin holes provided in the tape cassette for positioning. As a result, the tape cassette can be stably fixed, and the printing tape and the ink ribbon can be appropriately fed. Therefore, printing can be performed in a predetermined position of the printing tape, which improves quality of printing.

### BRIEF DESCRIPTION OF THE DRAWINGS

FIG. 1 is a perspective view of a tape cassette of a first exemplary embodiment;

FIG. 2 is a plan view of a lower case when a upper case is removed;

FIG. 3 is a schematic exploded perspective view of an attachment process of ends of a printing tape and an ink ribbon to a tape spool and an ink ribbon spool respectively;

FIG. 4 is a plan view of an attachment state of the ends of the printing tape and the ink ribbon to the tape spool and the ink ribbon spool respectively;

FIG. 5 is an explanatory view of an attachment process of the ends of the printing tape and the ink ribbon to the end of the adhesive tape configured to be longer than the other end;

FIG. 6 is an explanatory view of the attachment process of the ends of the printing tape and the ink ribbon to the end of the adhesive tape configured to be of two sheets which are partially overlapped one another when they are wound around and stuck to the tape spools;

FIG. 7 is an explanatory view of the attachment process in which the two sheets of the adhesive tape are not partially overlapped;

FIG. 8 is an explanatory view of the attachment process of the ends of the printing tape and the ink ribbon to the end of the adhesive tape when portions which are wound around the spools in the adhesive tape are not adhesive, but only the ends thereof are adhesive;

FIG. 9 is a sectional view of the ink ribbon take-up spool;

FIG. 10 is an exploded perspective view of a structure of an arm portion;

FIG. 11 is a sectional view of the tape spool when the tape cassette is placed with the lower case down;

FIG. 12 is a sectional view of a sliding lock piece when the tape cassette is mounted on a cassette mounted part.

FIG. 13A is a sectional view of the tape feed roller;

FIG. 13B is a plan view of the tape feed roller;

FIG. 14 is an enlarged explanatory view of a relation between a head holder of a thermal head and a head mounting recess when the tape cassette is mounted on the cassette mount part of a tape printer;

FIG. 15 is an exploded perspective view of a structure around the tape feed roller;

FIG. 16 is a sectional side view of the tape feed roller;

FIG. 17A is a top view of the tape cassette;

FIG. 17B is a back view of the tape cassette;

FIG. 18 is an explanatory view showing the tape cassette mounted on the cassette mount part of the tape printer;

FIG. 19 is an explanatory view of a relation between a cassette detection part and a detection switch when the tape cassette is mounted;

FIG. 20 is a schematic explanatory view showing the tape cassette mounted on the cassette mount part of the tape printer;

FIG. 21A is an explanatory top view of a logo formed part of the arm portion;

FIG. 21B is an explanatory sectional view of the logo formed part of the arm portion;

FIG. 22 is a plan view of the lower case of the tape cassette, shown without the upper case;

FIG. 23A is a top view of the logo formed part of the arm portion; and

FIG. 23B is a sectional view of the logo formed part of the arm portion.

### DETAILED DESCRIPTION

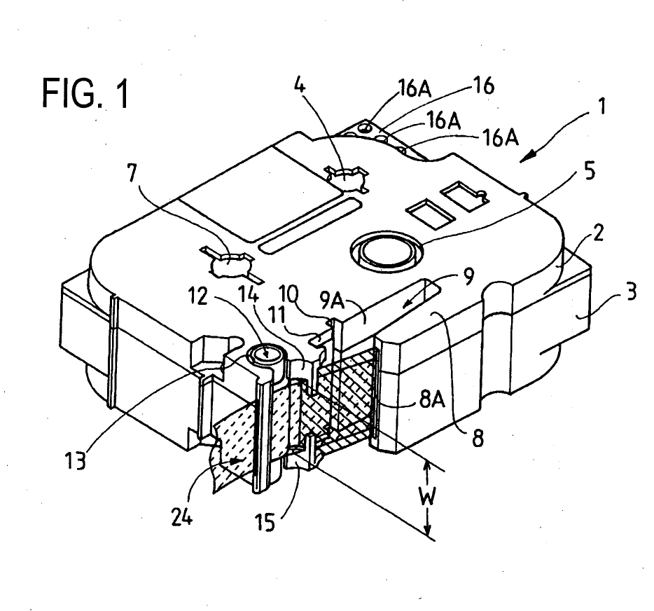

A detailed description of an exemplary embodiment of a tape cassette used in a tape printer P will now be given referring to the accompanying drawings. Firstly, a schematic structure of a tape cassette 1 will be explained with reference to FIG. 1. FIG. 1 is a perspective view of the tape cassette 1, which has an upper case 2 and a lower case 3.

The tape cassette 1 comprises support holes 4, 5 and 7. The support hole 4 rotatably supports a tape spool 18 on which a printing tape 17 described later is wound up. The support hole 5 supports an ink ribbon take-up spool 21 which unwinds an ink ribbon 19 from an ink ribbon spool 20 and takes up the ink ribbon 19 when characters are printed on the printing tape 17 with a thermal head H mentioned later. The support hole 7 rotatably supports a tape spool 23 on which a double-sided adhesive tape 22 described later is wound up with a release sheet thereof outward.

FIG. 1 shows only the support holes 4, 5 and 7 formed in the upper case 2. However, the support holes 4, 5 and 7 are also formed in the lower case 3, facing each of them in the upper case 2.

An arm portion 8 (a detailed structure thereof is described later) is provided on a front side of the tape cassette 1 (on a lower side in FIG. 1). The arm portion 8 guides the printing tape 17 unwound from the tape spool 18 and the ink ribbon 19 unwound from the ink ribbon spool 20, and discharges the printing tape 17 and the ink ribbon 19 through an opening 8A. Behind the opening 8A, there is provided a head mounting recess 9 in which the thermal head H (described later) of the tape printer P is placed. Further, a first coupling slot 10 grooved toward a rear side of the tape cassette 1 is formed in a wall portion 9A which faces the arm portion 8 in the head mounting recess 9. A second coupling slot 11 grooved in a direction perpendicular to the first coupling slot 10 (a direction along the wall portion 9A) is also formed on a left side wall of the head mounting recess 9. The first coupling slot 10 and the second coupling slot 11, as descried later, are provided in order to achieve a secure mounting of the thermal head H in the head mounting recess 9 without interference in the ink ribbon 19 and the printing tape 17, by being engaged with two projection parts 45, 46, which are formed in a head holder 44 supporting the thermal head H, respectively.

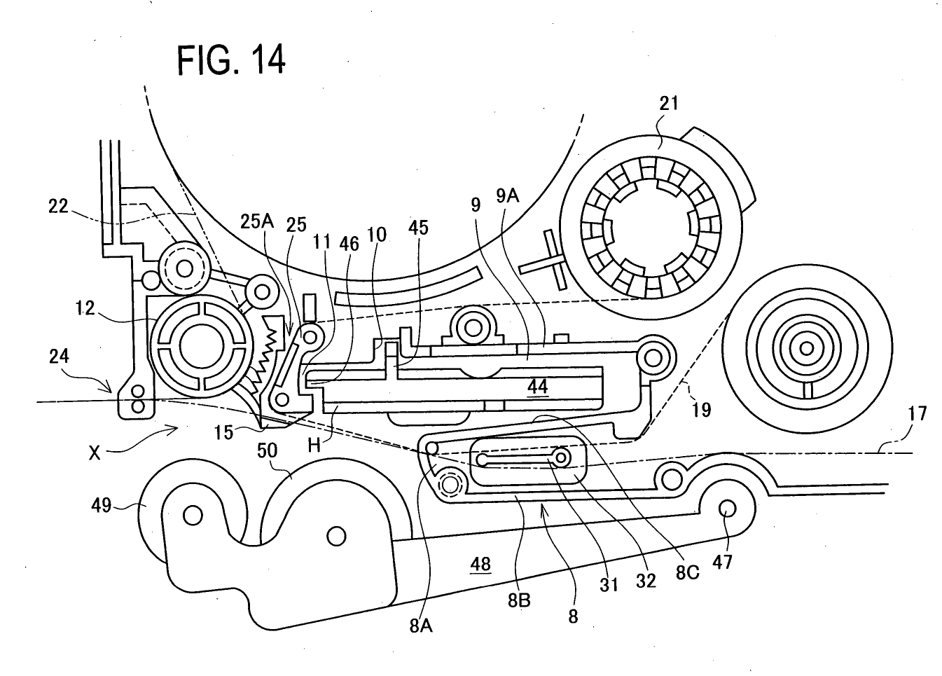

A tape feed roller 12 is rotatably supported by a support hole 13 on a downstream side of the head mounting recess 9 in a feeding direction of the ink ribbon 19 and the printing tape 17. The tape feed roller 12 cooperates with a pressing roller 49 (see FIG. 14) pressing against the tape feed roller 12 from the direction opposite to the tape feed roller 12 so that the printing tape 17 and the double-sided adhesive tape 22 are unwound from the tape spool 18 and the tape spool 23 respectively, and the printing tape 17 on which the characters are printed with the ink ribbon 19 and the double-sided adhesive tape 22 adhere. Further, a pair of upper and lower restricting members 14, 15 are provided close to the tape feed roller 12 to restrict and guide movement of the printed printing tape 17 in the width direction on a downstream side of the thermal head H, and so that the printing tape 17 and the double-sided adhesive tape 22 adhere properly without displacement therebetween. A structure of the tape feed roller 12 and the restricting members 14, 15 will be explained later in detail.

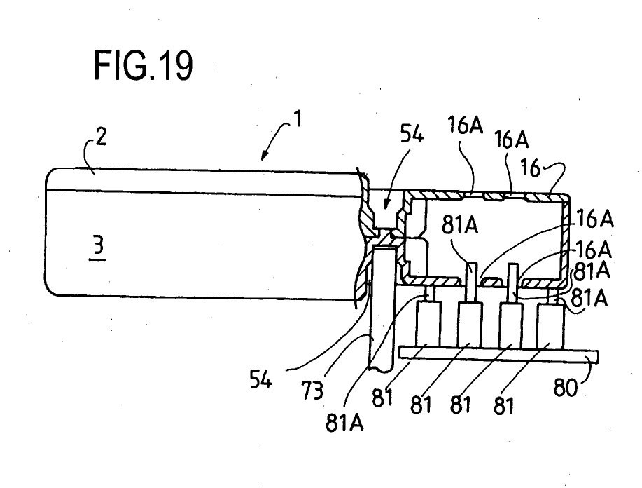

A cassette detection part 16 is formed at a right rear corner of the tape cassette 1. In the cassette detection part 16, a plurality of switch holes 16A of a predetermined pattern is perforated to detect a type of the tape cassette 1 (the type of the tape cassette 1 is determined by, for instance, a width of the printing tape 17, color of ink adhered on the ink ribbon 19). A pattern of formation of the switch holes 16A varies depending on the type of the tape cassette 1. The switch holes 16A are detected based on a combination of “on” and “off” states of detection switches 81 (see FIG. 19) arranged on the tape printer P. A structure of them will be described later.

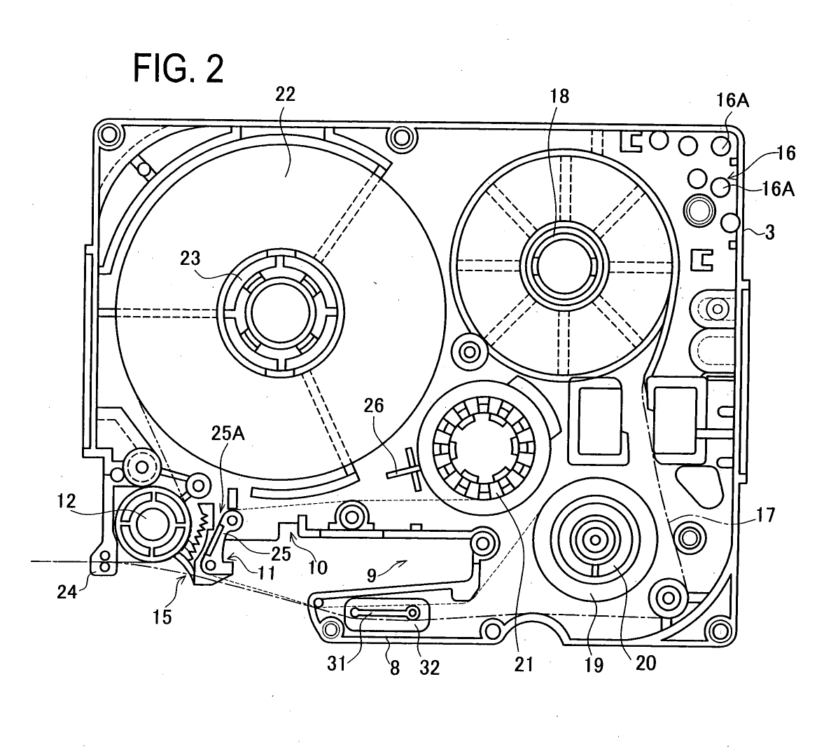

Next, an inner structure of the tape cassette 1 will be explained with reference to FIGS. 2 through 17. Firstly, the inner structure of the tape cassette 1 is briefly explained referring to FIG. 2. FIG. 2 is a plan view of the lower case 3 when the upper case 2 is removed. In a back part of the lower case 3 (in an upper part in FIG. 2), the tape spool 18 on which the transparent printing tape 17 is wound is turnably placed through the support hole 4. In a front part of the lower case 3 (in a lower part in FIG. 2), the ink ribbon spool 20 on which the ink ribbon 19 is wound is turnably placed. Further, the ink ribbon take-up spool 21 which unwinds the ink ribbon 19 from the ink ribbon spool 20 and takes up the ink ribbon 19 spent for printing of the characters is turnably placed between the tape spool 18 and the ink ribbon spool 20 through the support hole 5.

The printing tape 17 is unwound from the tape spool 18 in cooperation with the tape feed roller 12 and the pressing roller 49 (provided on the tape printer P) as mentioned above. After passed through the opening 8A of the arm portion 8 to a front side of the head mounting recess 9 (in the lower part in FIG. 2), the printing tape 17 adheres to the double-sided adhesive tape 22, and is discharged from a tape discharging slot 24 of the tape cassette 1. The ink ribbon 19 is unwound from the ink ribbon spool 20 by the ink ribbon take-up spool 21. After passed through the opening 8A of the arm portion 8 to the front side of the head mounting recess 9 (in the lower part in FIG. 2), the ink ribbon 19 runs through a guide groove 25A of a guide wall 25, and is wound on the ink ribbon take-up spool 21. It is noted that a clutch spring 26 is attached to a lower part of the ink ribbon take-up spool 21 in order to prevent the ink ribbon 19 wound on the ink ribbon take-up spool 21 from being loose because of a reverse rotation of the ink ribbon take-up spool 21.

Herein, the width of the ink ribbon 19 is configured to be wider than that of the printing tape 17, as shown in FIG. 1. This enables the printing tape 17 to be surely separated from the ink ribbon 19 on an upstream side of the restricting members 14, 15, and the ink ribbon 19 not to be unwound along with the printing tape 17 on a downstream side of the restricting members 14, 15. More specifically, a width (height) W defined between the restricting members 14, 15 is as wide as the printing tape 17 and thus set to be narrower than the ink ribbon 19. Accordingly, when the ink ribbon 19 is fed through the opening 8A of the arm portion 8 following the printing tape 17 and through the guide groove 25A of the guide wall 25, the ink ribbon 19 is blocked from entering a space between the restricting members 14, 15 since the width W between the restricting members 14, 15 is smaller than the width of the ink ribbon 19. As a result, the ink ribbon 19 can surely stop being fed to the downstream of the restricting members 14, 15 even when the ink ribbon 19 adheres to the printing tape 17 and runs together. Therefore, the ink ribbon 19 is never unwound more than necessary along with the printing tape 17 on the downstream side of the restricting members 14, 15.

This structure of the tape cassette 1 can avoid, even when the ink ribbon 19 becomes loose to a certain extent, the situation in which the tape cassette 1 becomes unusable due to jamming of the ink ribbon 19 caused by the printing tape 17 fed together with the ink ribbon 19 with adhesion thereto results in the ink ribbon 19 being unwound more than necessary and stuck to the double-sided adhesive tape 22.

Since the ink ribbon 19 is set to be wider than the printing tape 17, the ink ribbon 19 becomes wider than a width of the characters printed on the printing tape 17 as a matter of course. Therefore, in case the characters are continuously printed on the maximum printable area of the printing tape 17, there still remained unused areas on both sides of the ink ribbon 19. Consequently, the ink ribbon 19 can be avoided being cut. It is noted that the printing tape 17 is as wide as the double-sided adhesive tape 22 so that they adhere to each other to make the tape with the characters.

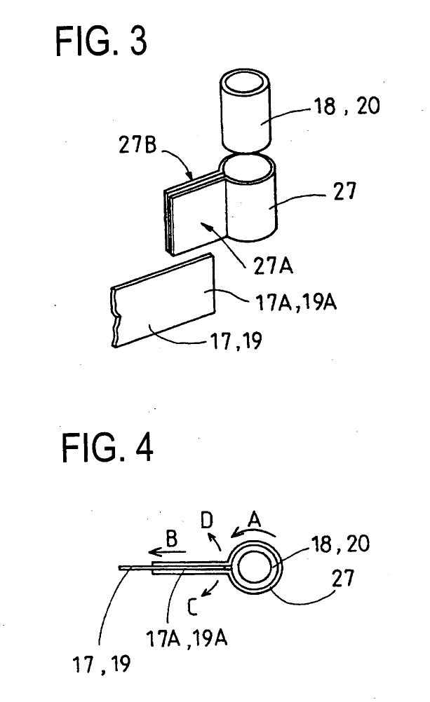

Herein, an attachment process of ends of the printing tape 17 and the ink ribbon 19 to the tape spool 18 and the ink ribbon spool 20 respectively will be explained with reference to FIGS. 3 and 4. FIG. 3 is a schematic exploded perspective view of an attachment process of the ends of the printing tape 17 and the ink ribbon 19 to the tape spool 18 and the ink ribbon spool 20 respectively. FIG. 4 is a plan view of an attachment state of the ends of the printing tape 17 and the ink ribbon 19 to the tape spool 18 and the ink ribbon spool 20 respectively.

In the figures, ends 17A and 19A of the printing tape 17 and the ink ribbon 19 are attached to the tape spool 18 and the ink ribbon spool 20 respectively by being secured and stuck between both ends 27A and 27B of an adhesive tape 27 which is wound on the tape spool 18 and the ink ribbon spool 20.

A power relation when pulling force is exerted on the printing tape 17 and the ink ribbon 19 which have attached to the tape spool 18 and the ink ribbon spool 20 respectively as described above will be explained referring to FIG. 4. Herein, the tape spool 18 and the ink ribbon spool 20 are rotated along an arrow A.

In this state, the pulling force exerted on the printing tape 17 and the ink ribbon 19 along an arrow B acts as force to separate the adhesive tape 27 from the tape spool 18 and the ink ribbon spool 20. More specifically, the pulling force operates as force overcoming a shearing resistance over a whole adhesive faces of the adhesive tape 27 and the spools 18, 20, or force stripping the both ends 27A and 27B of the adhesive tape 27 from the ends 17A and 19A of the printing tape 17 and the ink ribbon 19 respectively with a component force acting toward an arrow C and an arrow D of the pulling force, or a force stripping the adhesive tape 27 from the spools 18, 20.

In this time, the adhesive tape 27 is adhesively looped around the tape spool 18 and the ink ribbon spool 20. Therefore, the ends 17A and 19A of the printing tape 17 and the ink ribbon 19 are fixed to the tape spool 18 and the ink ribbon spool 20 strongly enough to resist the force to separate the adhesive tape 27 from the tape spool 18 and the ink ribbon spool 20. As a result, the adhesive tape 27 can avoid being easily separated from the spools 18 and 20.

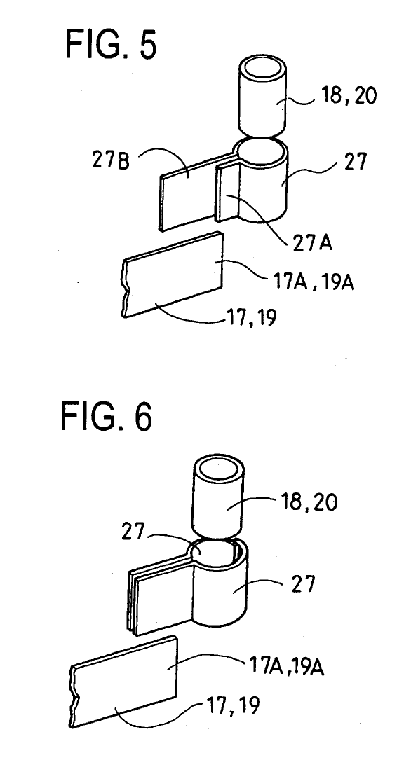

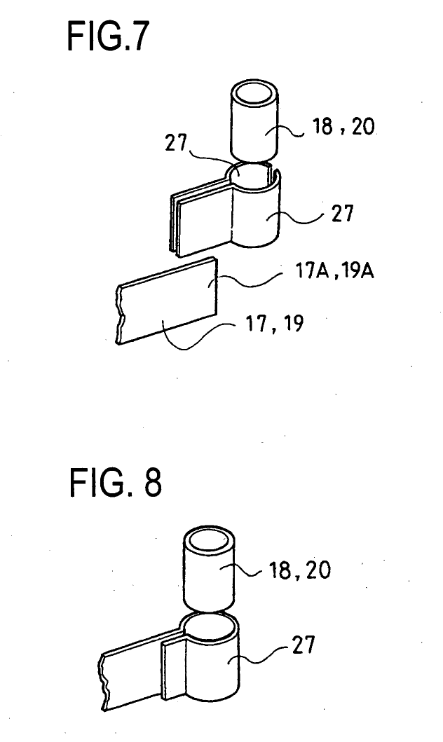

Further, the printing tape 17 and the ink ribbon 19 may attach to the tape spool 18 and the ink ribbon spool 20 respectively in a manner described in FIGS. 5 through 8. FIG. 5 is an explanatory view of an attachment process of the ends 17A, 19A of the printing tape 17 and the ink ribbon 19 to the end 27B of the adhesive tape 27 configured to be longer than the other end 27A. FIG. 6 is an explanatory view of the attachment process of the ends 17A, 19A of the printing tape 17 and the ink ribbon 19 to the end of the adhesive tape 27 configured to be of two sheets which are partially overlapped one another when they are wound on and stuck to the spools 18, 20. FIG. 7 is an explanatory view of the attachment process as same as FIG. 6, but the two sheets of the adhesive tape 27 are not partially overlapped. FIG. 8 is an explanatory view of the attachment process of the ends of the printing tape 17 and the ink ribbon 19 to the end of the adhesive tape 27 when portions which are wound on the spools in the adhesive tape are not adhesive, but only the ends thereof are adhesive.

Any of the attachment processes above enables the ends 17A and 19A of the printing tape 17 and the ink ribbon 19 to be strongly fixed to the tape spool 18 and the ink ribbon spool 20 respectively.

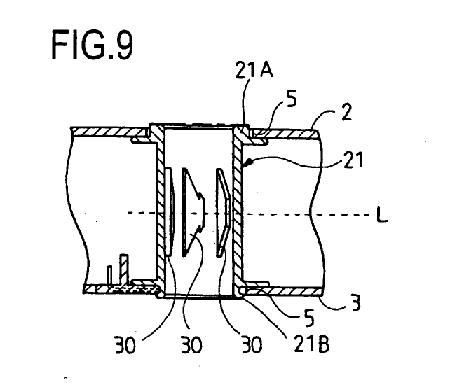

Next, a structure of the ink ribbon take-up spool 21 will be explained in FIG. 9. FIG. 9 is a sectional view of the ink ribbon take-up spool 21. The ink ribbon take-up spool 21 is turnably supported through the support hole 5 of the upper case 2 and the lower case 3. Around a center line L which is almost a center of an inner wall of the ink ribbon take-up spool 21 in a vertical direction, there are provided a plurality of engagement ribs 30. Each of the engagement ribs 30 is formed symmetrically about the center line L.

When the tape cassette 1 is mounted on a cassette mount part X of the tape printer P, an ink ribbon take-up shaft 65 placed on the cassette mount part X is inserted into the ink ribbon take-up spool 21. When the ink ribbon take-up shaft 65 is inserted into the ink ribbon take-up spool 21, a plurality of cam members 66 formed around the ink ribbon take-up shaft 65 are engaged with the engagement ribs 30, as is described later.

Further, each of the engagement ribs 30 of the ink ribbon take-up spool 21 is formed like following a rotary direction. Therefore, if the ink ribbon take-up spool 21 is placed upside down in the upper case 2 and the lower case 3, the ink ribbon take-up spool 21 cannot perform a rotary operation normally. To prevent this, a diameter of the support hole 5 in the upper case 2 is set larger than that in the lower case 3. At the same time, a diameter of an outer circumference of the ink ribbon take-up spool 21 in an upper portion 21A is set larger than that in a lower portion 21B. The upper portion 21A is engaged into the support hole 5 of the upper case 2, and the lower portion 21B is engaged into the support hole 5 in the lower case 3. This structure enables the ink ribbon take-up spool 21 to be always placed on the tape cassette 1 maintaining the position shown in FIG. 9, and wrong placement of the ink ribbon take-up spool 21 in the tape cassette 1 can be avoided.

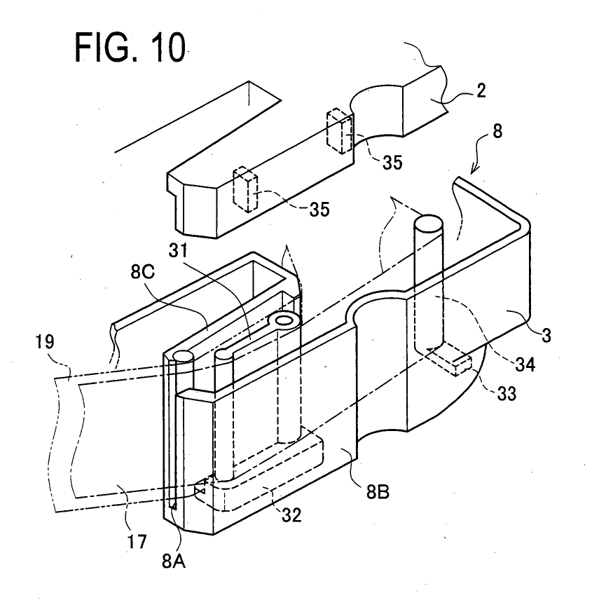

Next, a structure of the arm portion 8 for guiding the printing tape 17 and the ink ribbon 19 is explained with reference to FIG. 10. FIG. 10 is an exploded perspective view of the structure of the arm portion 8. The arm portion 8 of the lower case 3 consists of an outer wall 8B and an inner wall 8C which is higher than the outer wall 8B and as high as the width (height) of the ink ribbon 19. Between the outer wall 8B and the inner wall 8C, a partition wall 31 which is as high as the inner wall 8C is provided upright. In a lower end of the partition wall 31, a feeding restricting part 32 is formed. A guide pin 34 in which a feeding restricting part 33 is formed in a lower end thereof is provided on an upstream side (on a right side in FIG. 10) of the partition wall 31 in the arm portion 8 of the lower case 3. Further, a pair of feeding restricting parts 35 is formed on a portion in the upper case 2 which forms the arm portion 8, being positioned opposite to the feeding restricting part 32 provided in the lower end of the partition wall 31.

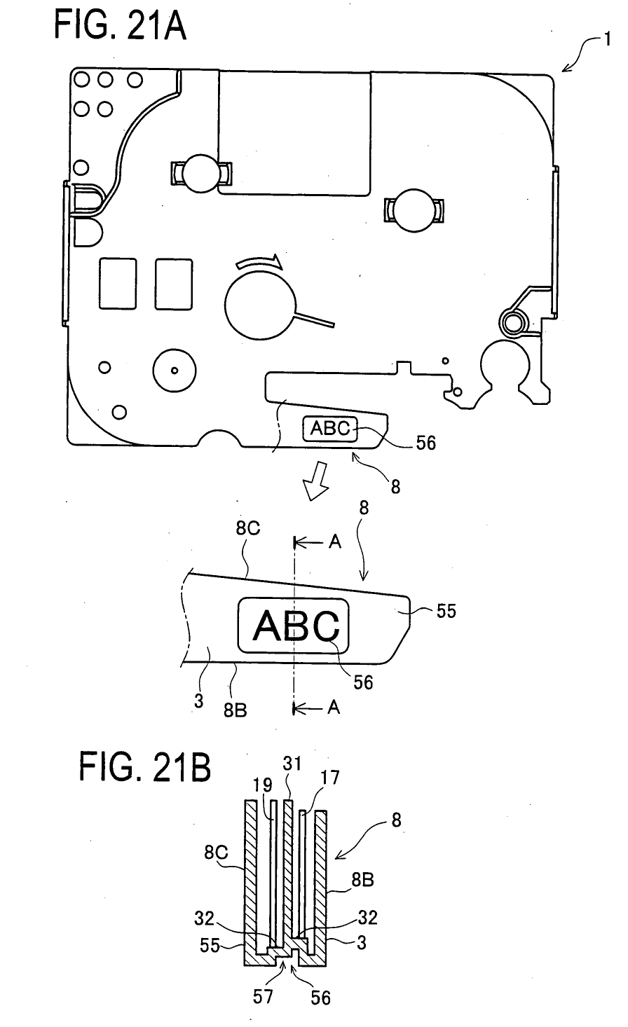

Herein, the feeding restricting part 32 will be explained based on FIGS. 21A and 21B. FIG. 21A is an explanatory top view of a logo formed part of the arm portion 8. FIG. 21B is an explanatory sectional view of the logo formed part of the arm portion 8. As shown in FIG. 21A, a logo formed part 56 is formed in a recessed shape in an outer wall face 55 of the lower case 3. The logo formed part 56, as shown in FIG. 19, has a protrusive part 57 which is formed like the contiguous recessions and projections to prevent a molding distortion and shrinkage in injection molding and to enhance strength of the parts. The partition wall 31 is provided on a top of the protrusive part 57. The printing tape 17 and the ink ribbon 19 run on each side of the partition wall 31 respectively, restricted by the feeding restricting part 32 with different levels. The printing tape 17 side of the feeding restricting part 32 is set higher than the ink ribbon 19 side because the printing tape 17 is narrower than the ink ribbon 19, so that the feeding restricting part 32 has the different levels (corresponding to a first and a second feeding regulating parts 32). Furthermore, a height of the feeding restricting part 32 is set higher (thicker) than a thickness of a wall of the lower case 3 for more strength enhancement.

When the upper case 2 and the lower case 3 are joined to each other to form the tape cassette 1, a printing tape feed path and an ink ribbon feed path are generated inside the arm portion 8. The printing tape feed path guides the printing tape 17 with the outer wall face 55, the partition wall 31 and the guide pin 34. The ink ribbon feed path guides the ink ribbon 19 with the inner wall 8C and the partition wall 31. In this case, the printing tape 17 is guided between the outer wall 8B and the partition wall 31 inside the arm portion 8 while the guide pin 34 changes the direction of the printing tape 17 of which a position of the lower end is restricted by the feeding restricting part 33, and while the feeding restricting part 32 at the lower end of the partition wall 31 and the feeding restricting parts 35 (see FIG. 10) in the upper case 2 cooperate to guide and restrict the movement of the printing tape 17 in the tape width direction. The ink ribbon 19 is guided between the inner wall 8C and the partition wall 31 inside the arm portion 8 while the inner wall 8C and the partition wall 31 which are as high as the ink ribbon 19 guide the ink ribbon 19. It is noted that, at the same time, an under surface of the upper case 2 and the feeding restricting part 32 provided in the lower case 3 restrict movement of the ink ribbon 19 in ribbon width direction.

As described above, the widths of the printing tape 17 and the ink ribbon 19 are different (the ink ribbon 19 is wider than the printing tape 17). Each of the printing tape feed path and the ink ribbon feed path is formed separately on either side of the partition wall 31 inside the arm portion 8. Accordingly, the printing tape 17 and the ink ribbon 19 can be independently and securely fed and guided along each feed path in spite of the different widths. Further, the ink ribbon 19 is fed and guided with the inner wall 8C and the partition wall 31 which are provided in the arm portion 8 of the lower case 3, so that the ink ribbon 19 can be set only in the lower case 3. The ink ribbon 19 can be thereby avoided being wrinkled between the upper case 2 and the lower case 3, and being entangled therebetween when the upper case 2 and the lower case 3 are joined. Furthermore, in the inner wall 8C and the partition wall 31 which are formed higher than the outer wall 8B of the lower case 3 in consideration of the width of the ink ribbon 19, only parts required to be higher may be formed higher. Other parts can be formed balancing with the heights of the outer wall 8B and the upper case 2. Therefore, it is unnecessary to form the whole lower case as high as the inner wall 8C and the partition wall 31. As a result of this, the lower case 3 is easily formable without difficulties especially in molding.

The explanation of the inner structure of the tape cassette 1 now goes back to FIG. 2. On the left side of the lower case 3, the support hole 7 turnably supports the tape spool 23 on which the double-sided adhesive tape 22 is wound up with its release sheet outward. The double-sided adhesive tape 22 is unwound from the tape spool 23, and adheres to the printed face of the printing tape 17 on which the characters are printed with the thermal head H, and is discharged from the tape discharging slot 24 of the tape cassette 1, as described before, in cooperation with the tape feed roller 12 and the pressing roller 49 provided in the tape printer P.

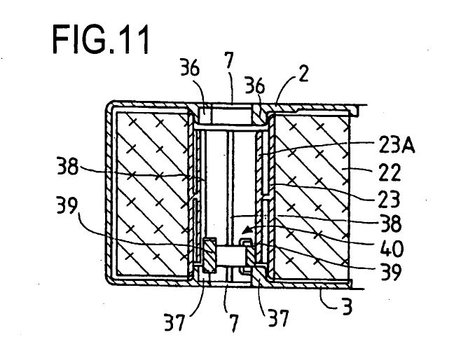

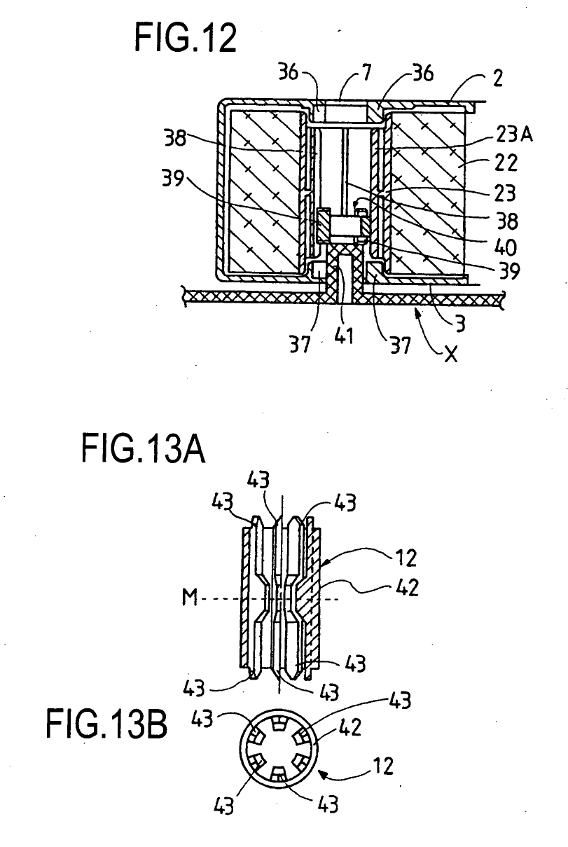

Next, the structure of the tape spool 23 will be explained with reference to FIGS. 11 and 12. Firstly, the state before the tape cassette is mounted on the tape printer P is explained referring to FIG. 11. FIG. 11 is a sectional view of the tape spool 23 when the tape cassette 1 is placed with the lower case 3 down.

In FIG. 11, a plurality of engaging ribs 36 are formed radially from a center and around the support hole 7 of the upper case 2. Like the engaging ribs 36, a plurality of engaging ribs 37 are formed radially from the center and around the support hole 7 of the lower case 3. The tape spool 23 has a dual-wall construction, and four sliding grooves 38 are formed in a vertical direction in the inner wall 23A. Each one of these four sliding grooves 38 is formed in an axial direction at 90 degree intervals around the inner wall 23A.

A cylindrical sliding lock piece 40, which bears four sliding protrusions 39 for being slidably engaged with each of the sliding grooves 38 and slides vertically in the tape spool 23, is inserted in the tape spool 23. Each of the sliding protrusions 39 is also engageable with the engaging ribs 37 of the lower case 3 or the engaging ribs 36 of the upper case 2, according to the orientation of the tape cassette 1. For instance, when the tape cassette 1 is mounted with the lower case downward as shown in FIG. 11, each of the sliding protrusions 39 of the sliding lock piece 40 is engaged with the engaging ribs 37 of the lower case 3. When each of the sliding protrusions 39 of the sliding lock piece 40 is disengaged from the engaging ribs 37 of the lower case 3, the sliding lock piece 40 rotates together with the tape spool 23 due to the engagement of the sliding protrusions 39 with the sliding grooves 38 of the tape spool 23.

In the structure as described above, each of the sliding protrusions 39 which is engaged with the engaging ribs 37 of the lower case 3 is also engaged in the sliding grooves 38 of the tape spool 23. As a result, the tape spool 23 is kept being locked from rotating.

Consequently, when the tape cassette 1 is mounted like a state of FIG. 11, the tape spool 23 is locked from rotating. This can prevent the double-sided adhesive tape 22 from being accidentally unwound outward from the tape cassette 1, and withdrawn into the tape cassette 1.

A state of the tape cassette 1 mounted on the cassette mount part X of the tape printer P will be explained in FIG. 12. FIG. 12 is a sectional view of the sliding lock piece 40 when the tape cassette 1 is mounted on the cassette mount part X. In FIG. 12, a boss 41 is provided upright in the cassette mount part X of the tape printer P, in alignment with the support hole 7 of the tape cassette 1. The boss 41 is inserted into the support hole 7 when the tape cassette 1 is mounted.

When the tape cassette 1 is mounted on the cassette mount part X of the tape printer P, the boss 41 is inserted into the support hole 7 of the tape cassette 1, and therefore pushes up the sliding lock piece 40 inside the tape spool 23. Consequently, the engagement of the sliding protrusions 39 of the sliding lock piece 40 to the engaging ribs 37 of the lower case 3 is released, and the tape spool 23 becomes rotatable together with the sliding lock piece 40. Subsequently, the double-sided adhesive tape 22 can be unwound from the tape spool 23 via the tape feed roller 12, and the normal tape forming operation becomes possible.

As described above, when the tape cassette 1 is removed from the cassette mount part X of the tape printer P, the engagement of the sliding protrusions 39 of the sliding lock piece 40 with both the engaging ribs 37 of the lower case 3 and the sliding grooves 38 of the tape spool 23 can prevent the double-sided adhesive tape 22 from being accidentally unwound from the tape cassette 1, or withdrawn into the tape cassette 1. Further, when the tape cassette 1 is mounted on the cassette mount part X of the tape printer P, the engagement of the sliding protrusions 39 of the sliding lock piece 40 to the engaging ribs 37 of the lower case 3 is released. Therefore, the tape spool 23 can be freely rotated without rotational load thereon to carry out the tape making operation.

Next, the structure of the tape feed roller 12 will be explained with reference to FIGS. 13A and 13B. FIG. 13A is a sectional view of the tape feed roller 12, and FIG. 13B is a plan view of the tape feed roller 12.

As shown in FIGS. 13A and 13B, the tape feed roller 12 includes a cylindrical portion 42 made of a plastic material in a cylindrical shape and a plurality of drive ribs 43 projecting inward radially from the inner wall of the cylindrical portion 42. A plurality of the drive ribs 43 are vertically symmetrically formed on each side of a vertically central position of the cylindrical portion 42 (indicated in FIG. 13A by a broken line M). Each of the drive ribs 43 is engaged with a cam part 69 of a tape drive cam 70 (described later) provided on the cassette mount part X of the tape printer P to rotate the tape feed roller 12 in cooperation with cam part 69 and the drive ribs 43 along with a rotational movement of the tape drive cam 70. Thereby, the tape feed roller 12 can carry out the feeding operation, laminating the double-sided adhesive tape 22 and the printing tape 17 and feeding the tapes 22 and 17 out of the tape cassette 1 through the tape discharging slot 24.

Relations between the head holder 44 of the thermal head H and the head mounting recess 9, and between the tape feed roller 12 and restricting members 14, 15 close to the upstream side of the tape feed roller 12 will be explained with reference to FIGS. 14 through 16. Firstly, the relation between the head holder 44 of the thermal head H and the head mounting recess 9 will be explained based on FIG. 14.

FIG. 14 is an enlarged explanatory view of the relation between the head holder 44 of the thermal head H and the head mounting recess 9 when the tape cassette 1 is mounted on the cassette mount part X of the tape printer P. In the head mounting recess 9 provided in the tape cassette 1, as mentioned above (see FIGS. 1 and 2), the first coupling slot 10 (grooved upward in FIG. 14) is formed on the wall portion 9A of the head mounting recess 9. The second coupling slot 11 grooved in a direction perpendicular to the first coupling slot 10 is also formed on a left side wall of the head mounting recess 9. Further, the thermal head H is mounted on the head holder 44 which is fixed on the cassette mount part X. The head holder 44 includes the first projection part 45 which is engaged in the first coupling slot 10 and the second projection part 46 which is engaged in the second coupling slot 11.

When the tape cassette 1 is mounted on the cassette mount part X under the above structure, the first coupling slot 10 of the head mounting recess 9 of the tape cassette 1 is firstly positioned in the first projection part 45 of the head holder 44. At the same time, the second coupling slot 11 of the head mounting recess 9 is also positioned in the second projection part 46 of the head holder 44. Next, the tape cassette 1 is mounted on the cassette mount part X from the above direction. When the tape cassette 1 is mounted on the cassette mount part X, the tape cassette 1 is positioned properly in right and left directions by means of the first coupling slot 10 and the first projection part 45, and in front and rear directions by means of the second coupling slot 11 and the second projection part 46. In this manner, the tape cassette 1 cannot be mounted on the cassette mount part X correctly before the tape cassette 1 is positioned in the right and left directions with the first coupling slot 10 and the first projection part 45 and in the front and rear directions with the second coupling slot 11 and the second projection part 46, so that the tape cassette 1 is mounted maintaining a position in a fixed relation to the cassette mount part X. It is therefore possible to mount the tape cassette 1 correctly and easily on the cassette mount part X unless the printing tape 17 and the ink ribbon 19 exposed at the head mounting recess 9 are brought into contact with the thermal head H and the head holder 44.

It is noted that, in FIG. 14, a roller holder 48 which faces the tape cassette 1 and is supported rotatably about a support shaft 47 is placed in the cassette mount part X of the tape printer P. In the roller holder 48, the pressing roller 49 and a platen roller 50 are turnably supported. The pressing roller 49 carries out the feeding operation in cooperation with the tape feed roller 12, and is pressed against tape feed roller 12. The platen roller 50 is pressed against the thermal head H.

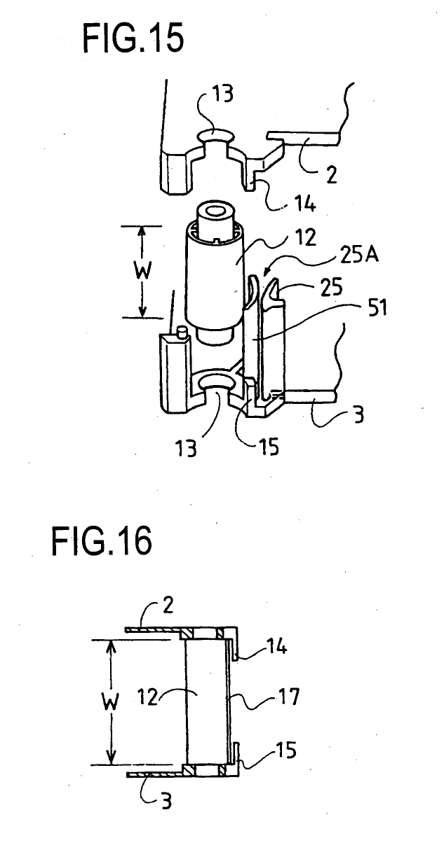

Next, a relation between the tape feed roller 12 and the restricting members 14, 15 close to and on the upstream side of the tape feed roller 12 will be explained with reference to FIGS. 15 and 16. FIG. 15 is an exploded perspective view of the structure around the tape feed roller 12. FIG. 16 is a sectional side view of the tape feed roller 12.

In FIGS. 15 and 16, the restricting member 14 is provided near the support hole 13 of the tape feed roller 12 formed in the upper case 2. The restricting member 15 is formed under the restricting wall 51 which is provided upright near the support hole 13 of the tape feed roller 12 formed in the lower case 3. When the tape cassette 1 is assembled with a joint of the upper and lower cases 2, 3, the width W (see FIG. 1) between the lower end of the upper restricting member 14 and the upper end of the lower restricting member 15 is set same as the width of the printing tape 17 as aforementioned. A tape feed width of the tape feed roller 12 is set same as the width W between the restricting members 14, 15. The guide wall 25 is placed upright next to the restricting wall 51, and the guide groove 25A is provided between the restricting wall 51 and the guide wall 25.

In the above structure, after the printing tape 17 is printed the characters thereon by the thermal head H with the ink ribbon 19, the ink ribbon 19 spent for printing is wound up by the ink ribbon take-up spool 21. At the same time, the printing tape 17 is fed to a discharge direction by means of the tape feed roller 12 and the pressing roller 49. At this time, the ink ribbon 19 is wider than the printing tape 17, so that the ink ribbon 19 is not fed to between the restricting members 14, 15, but wound up by the ink ribbon take-up spool 21 through the guide groove 25A which is provided between the restricting wall 51 and the guide wall 25. On the contrary, the width of the printing tape 17 is as same as the width W between the restricting members 14, 15, so that the printing tape 17 is fed to the tape feed roller 12 while the restricting members 14, 15 restrict and guide the movement of the printing tape 17 in the tape width direction. The double-sided adhesive tape 22 is simultaneously fed to the printing tape 17, aligned with the tape feed width of the tape feed roller 12 which is same as the width of the double-sided adhesive tape 22. The printing tape 17 and the double-sided adhesive tape 22 are thereby able to properly adhere to each other without displacement therebetween, in cooperation with the tape feed roller 12 and the pressing roller 49.

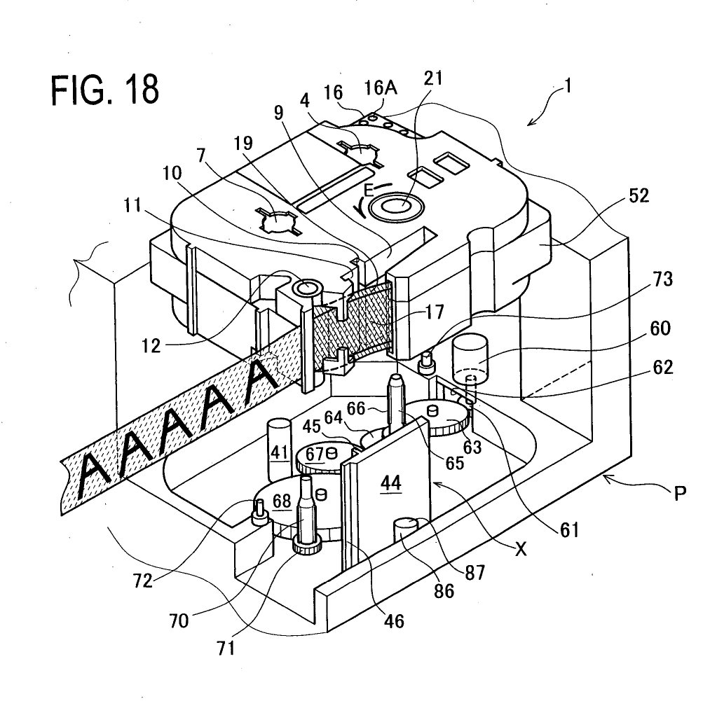

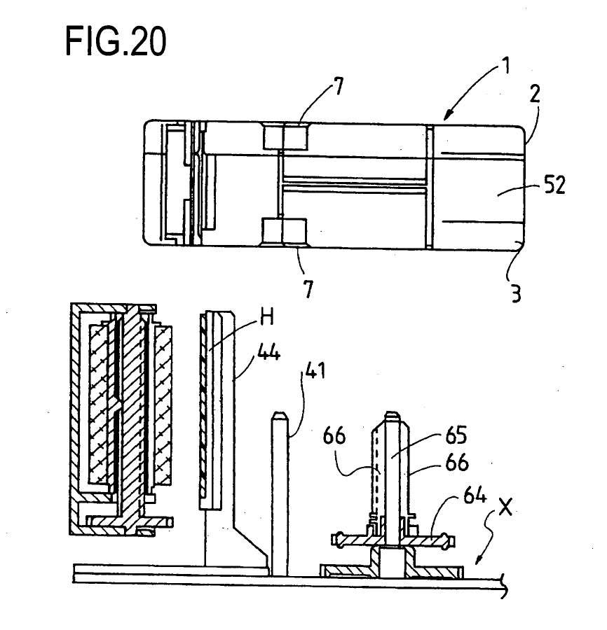

Next, a process of the tape cassette 1 of the structure described above to be mounted on the cassette mount part X of the tape printer P will be explained with reference to FIGS. 18, 19 and 20. FIG. 18 is an explanatory view showing the tape cassette 1 mounted on the cassette mount part X of the tape printer P. FIG. 19 is an explanatory view of a relation between the cassette detection part 16 and the detection switch when the tape cassette 1 is mounted. FIG. 20 is a schematic explanatory view showing the tape cassette 1 mounted on the cassette mount part X of the tape printer P.

Firstly, the structure of the cassette mount part X of the tape printer P is explained with reference to FIG. 18. In the cassette mount part X, the head holder 44, which has the thermal head H, is fixedly provided to the front side of the cassette mount part X. A drive motor 60 is arranged on one lateral side of the cassette mount part X (right side in FIG. 18), and a drive gear 61 is secured at the lower end of the drive shaft of the drive motor 60. The drive gear 61 meshes with a gear 63 rotatably supported at the bottom surface of the cassette mount part X through an opening 62 formed in the cassette mount part X. The gear 63 further meshes with a gear 64. The ink ribbon take-up shaft 65 that drives the ink ribbon take-up spool 21 is provided on the upper surface of the gear 64. The cam members 66, which are engaged with the engagement ribs 30 (see FIG. 9) formed in the inner wall of the ink ribbon take-up spool 21, are provided around the ink ribbon take-up shaft 65.

The gear 64 meshes with a gear 67, which further meshes with a gear 68. The gear 68 meshes with a gear 71, on which the tape drive cam 70 including the cam part 69 engaged with the drive rib 43 (see FIGS. 13A and 13B) of the tape feed roller 12 is provided upright.

When the tape cassette 1 is mounted on the cassette mount part X from the state shown by FIGS. 18 and 20, the ink ribbon take-up shaft 65 is rotated and driven in a counterclockwise direction via the drive gear 61, the gears 63, 64 with the drive motor 60 which is rotated in the counterclockwise direction in the components of the cassette mount part X. As a result, the ink ribbon take-up spool 21 is rotated in a direction of an arrow E in cooperation with the cam members 66 of the ink ribbon take-up shaft 65 and the engagement ribs 30 to wind up the ink ribbon 19. Further, a rotation of the gear 64 is conveyed to the tape drive cam 70 via the gears 67, 68 and 71. This enables the tape feed roller 12 to be rotated in a clockwise direction with the cam part 69 of the tape drive cam 70 and the drive ribs 43 of the tape feed roller 12, and to discharge the printing tape 17 and the double-sided adhesive tape 22 from the tape discharging slot 24 of the tape cassette 1, adhering the both tapes to each other in cooperation with the pressing roller 49.

The boss 41 (see FIG. 12) is provided between the gears 67 and 68 in the cassette mount part X. The boss 41, as mentioned above, pushes the sliding lock piece 40 upwardly in the tape spool 23 to release the engagement of the sliding protrusions 39 of the sliding lock piece 40 with the engaging ribs 37 of the lower case 3, when the tape cassette 1 is mounted on the cassette mount part X of the tape printer P. Consequently, the tape spool 23 is set free from the engagement, and can be freely rotated with the sliding lock piece 40.

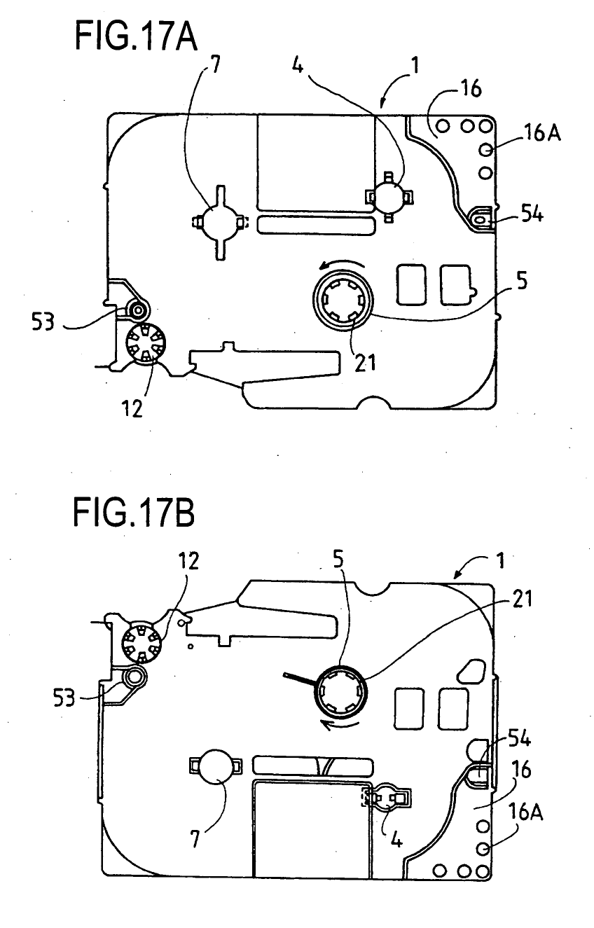

Furthermore, two positioning pins 72, 73 are provided around the cassette mount part X. The positioning pins 72, 73 are inserted into pin holes 53, 54 (see FIG. 17A, 17B) to position correctly the tape cassette 1 in the cassette mount part X.

Next, a relation between the cassette detection part 16 and the detection switches 81 when the tape cassette 1 is mounted on the cassette mount part X will be explained with reference to FIG. 19. In FIG. 19, a switch support member 80 is provided in the rear of the cassette mount part X. The four detection switches 81 are arranged on the switch support member 80, facing upward. Each of the detection switches 81 has a switch terminal 81A. Each detection switch 81 maintains an OFF state under the condition in which each switch terminal 81A is inserted into each of the switch holes 16A, which are perforated in the cassette detection part 16 in a predetermined pattern. On the other hand, the switch terminal 81A is depressed where the switch holes 16A do not exist, and the detection switch 81 is turned to an ON state. Accordingly, the type of the tape cassette 1 is detected based on the combination of the ON and OFF states of these detection switches 81.

When the tape cassette 1 is mounted as mentioned above, taking FIG. 19 as an example, outer two of four detection switches 81 are ON except the middle two. Therefore, the ON-OFF pattern of the example is “ON-OFF-OFF-ON” from left to right, so that the type of the tape cassette 1 is detected based on the combination as such.

As described in detail above, in the tape cassette 1 of the first exemplary embodiment, logos including the characters and the symbols are formed in the recessed shape in a position facing to the feed paths of the printing tape 17 and the ink ribbon 19 in the logo formed part 56 of the outer wall face 55 of the lower case 3. The protrusive part 57, which is formed in an inner wall face of the lower case 3 as the logos are formed, provides the feeding restricting part 32 which restricts the movement of the printing tape 17 and the ink ribbon 19 in the tape width direction. Accordingly, the protrusive part 57 is formed like the contiguous recessions and projections in the inner wall face of the lower case 3, so that the strength of the parts can be enhanced rather than being a rib of a single plate, and molding distortion in injection molding can be saved. It becomes also possible to prevent the shrinkage which is caused by unevenness of resin shrinkage in injection molding in the feeding restricting part 32 like the rib of the single plate. As a result, a dimension of the feeding restricting part 32 can be fixed, and then the printing tape 17 and the ink ribbon 19 can be fed properly. Furthermore, the protrusive length (height) of the protrusive part 57 from the inner wall face of the lower case 3 is set larger than the thickness of the wall of the lower case 3. This makes it possible to enhance the strength of the protrusive part 57 which is formed like the contiguous recessions and projections.

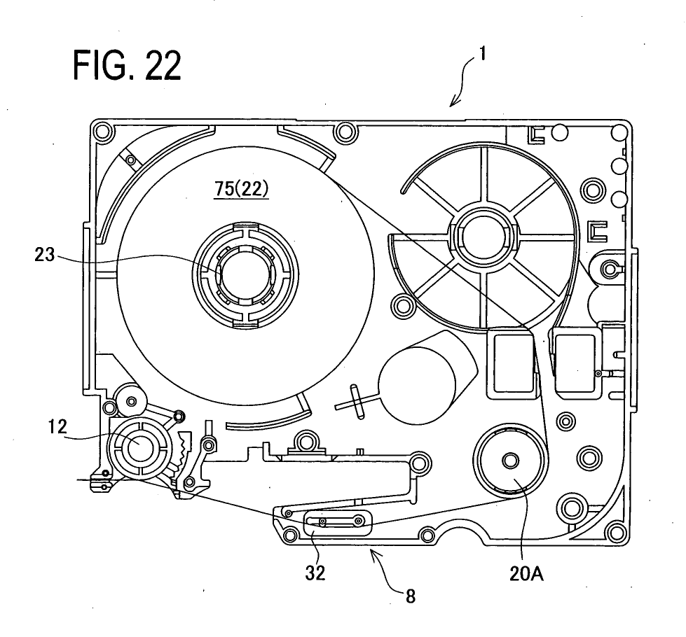

Next, the tape cassette of a second exemplary embodiment of the disclosure will be explained with reference to FIG. 22. FIG. 22 is a plan view of the lower case of the tape cassette, shown without the upper case. Parts which are functionally the same as those in the first exemplary embodiment are assigned the identical reference numerals to those in the first exemplary embodiment. The structure of the tape cassette of the second exemplary embodiment is same as that of the tape cassette 1 of the first exemplary embodiment. However, instead of the transparent printing tape 17 and the double-sided adhesive tape 22, a heat-sensitive printing tape 75 in which an adhesive is previously applied to a back face is wound on the tape spool 23 with a release paper outside, and is housed in the tape cassette 1. Furthermore, on the upper and the lower ends of the heat-sensitive printing tape 75, spacers (not shown) made of resin film are inserted. On the lower part of one side of the tape cassette 1 (on the lower left side in FIG. 22), the tape feed roller 12 which is rotated by the drive motor 60 (see FIG. 18) is turnably placed. The tape feed roller 12 is formed as wide as or wider than the housed heat-sensitive printing tape 75.

The heat-sensitive printing tape 75 which is unwound from the tape spool 23 is fed between the thermal head H and the platen roller 50 via a guide spool 20A and the arm portion 8. The platen roller 50 comprises a function of pressing the heat-sensitive printing tape 75 against the thermal head H in printing. The heat-sensitive printing tape 75 which is printed with the thermal head H passes between the tape feed roller 12 and the pressing roller 49. The pressing roller 49 comprises functions of pressing a printed face of the heat-sensitive printing tape 75 against the tape feed roller 12, and discharging the heat-sensitive printing tape 75 from the tape cassette 1.

The structure of the arm portion 8 is same as that disclosed in the first exemplary embodiment. However, the tape cassette 1 of the second exemplary embodiment does not comprise the ink ribbon 19 but the heat-sensitive printing tape 75 instead of the printing tape 17, as compared with the tape cassette 1 of the first exemplary embodiment shown in FIG. 21B. The structure will be explained referring to FIG. 21B. As shown in FIG. 21B, the logo formed part 56 has the protrusive part 57 which is formed like the contiguous recessions and projections to prevent the molding distortion and shrinkage in injection molding and to enhance strength of the parts. The partition wall 31 is provided on the top of the protrusive part 57. The heat-sensitive printing tape 75 runs on one side (on right side in FIG. 21B) of the partition wall 31, while the feeding restricting part 32 restricts movement of the heat-sensitive printing tape 75. The height of the feeding restricting part 32 is set higher (thicker) than the thickness of the wall of the lower case 3 for more strength enhancement.

When the upper case 2 and the lower case 3 are joined to each other to form the tape cassette 1, a heat-sensitive printing tape feed path is generated inside the arm portion 8. The heat-sensitive printing tape feed path guides the heat-sensitive printing tape 75 with the outer wall 8B, the partition wall 31 and the guide spool 20A. In this case, the heat-sensitive printing tape 75 is guided between the outer wall 8B and the partition wall 31 inside the arm portion 8 while the guide spool 20A changes the direction of the heat-sensitive printing tape 75, and while the feeding restricting part 32 at the lower end of the partition wall 31 and the feeding restricting parts 35 (see FIG. 10) in the upper case 2 cooperate to guide and restrict the movement of the printing tape 17 in the tape width direction.

As described in detail above, in the tape cassette 1 of the second exemplary embodiment, the logos including the characters and the symbols are formed in the recessed shape in a position facing to the feed path of the heat-sensitive printing tape 75 in the logo formed part 56 of the outer wall face 55 of the lower case 3. The protrusive part 57, which is formed in an inner wall face of the lower case 3 as the logos are formed, provides the feeding restricting part 32 which restricts the movement of the heat-sensitive printing tape 75 in the tape width direction. Accordingly, the protrusive part 57 is formed like the contiguous recessions and projections in the inside wall of the lower case 3, so that the strength of the parts can be enhanced rather than being the rib of the single plate, and molding distortion in injection molding can be saved. It becomes also possible to prevent the shrinkage which is caused by the unevenness of resin shrinkage in injection molding in the feeding restricting part 32 like the rib of the single plate. As a result, a dimension of the feeding restricting part 32 can be fixed, and then the heat-sensitive printing tape 75 can be fed properly. Furthermore, the protrusive length (height) of the protrusive part 57 from the inner wall face of the lower case 3 is set larger than the thickness of the wall of the lower case 3. This makes it possible to enhance the strength of the protrusive part 57 which is formed like the contiguous recessions and projections.

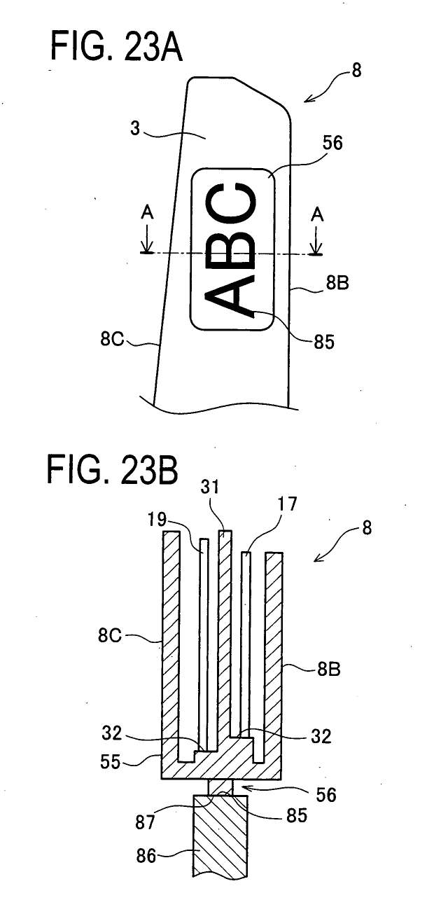

Next, the tape cassette of a third exemplary embodiment of the disclosure will be explained with reference to FIGS. 23A and 23B. Parts which are functionally the same as those in the first and second exemplary embodiments are assigned the identical reference numerals to those in the first and second exemplary embodiments. FIG. 23A is a top view of the logo formed part of the arm portion. FIG. 23B is a sectional view of the logo formed part of the arm portion. Firstly, the logo formed part 56 is formed in a protruding shape in the outer wall face 55 of the lower case 3, as shown in FIG. 23A. A top face 85 of the logo formed part 56 formed in the protruding shape as shown in FIG. 23B is used as a reference face in a height direction of the tape cassette 1, coming into contact with an end face 87 of a cassette positioning member 86 provided in the tape printer P. Consequently, the tape cassette 1 can be stably fixed by three points including positioning pins 72, 73 (shown in FIG. 18) and the end face 87 of the cassette positioning member 86, each of which corresponds to the pin holes 53, 54 and the top face 85 of the logo formed part 56 respectively. This enables the tape and the ink ribbon to be fed properly.

As described in detail above, in the tape cassette 1 of the third exemplary embodiment, the logos including the characters and the symbols are formed like the protrusion in a position facing to the feed paths of the printing tape 17 and the ink ribbon 19 in the logo formed part 56 of the outer wall face 55 of the lower case 3. The top face 85 of the protrusive logos is used as the reference face in the height direction of the tape cassette 1. Therefore, it becomes possible to position the tape cassette 1 in the height direction with the top face 85 of the protrusive logos which feeds the printing tape 17 and the ink ribbon 19 for printing of the characters. The tape cassette 1 can be also positioned by the three points including the top face 85 of the protrusive logos and two pin holes 53, 54 provided in the tape cassette 1 for positioning. As a result, the tape cassette 1 can be stably fixed, and the printing tape 17 and the ink ribbon 19 can be appropriately fed. Therefore, printing can be performed in a predetermined position of the printing tape 17, which improves quality of printing.

The disclosure may be embodied in other specific forms without departing from the essential characteristics thereof. For instance, in the third exemplary embodiment, the logos are formed like the protrusion. The partition wall or the feeding restricting part may be formed inside the recession formed inside the protrusion.

While the presently exemplary embodiment of the disclosure has been shown and described, it is to be understood that this disclosure is for the purpose of illustration and that various changes and modifications may be made without departing from the scope of the disclosure as set forth in the appended claims.

What is claimed is:

1. A tape cassette including a cassette case housing a tape spool on which a printing tape is wound and an ink ribbon spool on which an ink ribbon is wound, in which the printing tape on which a character has been printed with the ink ribbon is discharged from the cassette case while the printing tape and the ink ribbon are unwound from the tape spool and the ink ribbon spool respectively along a predetermined feed guidance, the tape cassette comprising:
a logo including a character and a symbol, formed in a recessed shape in a position facing to the feed guidance in an outer wall face of the cassette case; and
a protrusive part formed in an inner wall face of the cassette case as the logo is formed, and providing a feeding restricting part for restricting movement of the printing tape and the ink ribbon in respective width direction.

2. The tape cassette according to claim 1,
wherein the feeding restricting part includes a first feeding restricting part for the printing tape and a second feeding restricting part for the ink ribbon which are different in height.

3. The tape cassette according to claim 2,
wherein the first feeding restricting part for the printing tape is higher than the second feeding restricting part for the ink ribbon.

4. The tape cassette according to claim 1,
wherein a partition wall for separating the printing tape and the ink ribbon on the feed guidance is provided upright on the protrusive part.

5. The tape cassette according to claim 1,
wherein a protrusive length of the protrusive part from the inner wall face of the cassette case is set larger than a thickness of a wall of the cassette case.

6. A tape cassette including a cassette case housing a tape spool on which a heat-sensitive printing tape is wound, in which the printing tape on which a character has been printed with the ink ribbon is discharged from the cassette case while the heat-sensitive printing tape is unwound from the tape spool along a predetermined feed guidance, the tape cassette comprising:
a logo including a character and a symbol, formed in a recessed shape in a position facing to the feed guidance in an outer wall face of the cassette case; and
a protrusive part formed in an inner wall face of the cassette case as the logo is formed, and providing a feeding restricting part for restricting movement of the heat-sensitive printing tape in width direction.

7. The tape cassette according to claim 6,
wherein a protrusive length of the protrusive part from the inner wall face of the cassette case is set larger than a thickness of a wall of the cassette case.

8. A tape cassette including a cassette case housing a tape spool on which one of a printing tape and a heat-sensitive printing tape is wound, in which one of the printing tape and the heat-sensitive printing tape on which a character has been printed with the ink ribbon is discharged from the cassette case while one of the printing tape and the heat-sensitive printing tape is unwound from the tape spool and the ink ribbon spool respectively along a predetermined feed guidance, the tape cassette comprising:
a protrusive logo including a character and a symbol, formed in a protruding shape in a position facing to the feed guidance in an outer wall face of the cassette case; and
a top face of the protrusive logo is used as a reference face in a height direction of the tape cassette.

9. The tape cassette according to claim 8,
wherein the tape cassette is mountable in a cassette mount part of a tape printer, including an end face of a cassette positioning member of a tape printer, in which the printing tape or the heat-sensitive printing tape is discharged from the cassette case after printing, and
the top face of the protrusive logo is brought into contact with the end face of the cassette positioning member provided in the cassette mount part when the tape cassette is mounted on the cassette mount part of the tape printer.

10. The tape cassette according to claim 9,
wherein the tape cassette is mountable on the tape printer so that the top face of the protrusive logo and two pin holes provided in opposite sides of a plane, flush with the top face of the protrusive logo, are brought into contact with and fixed to the end face of the cassette positioning member provided in the cassette mount part and positioning pins provided in a position of the cassette mount part facing to the two pin holes provided in the tape cassette.
